(19) United States
(12) Patent Application Publication
(10) Pub. No.: US 2026/0271958 A1
(43) Pub. Date: Sep. 17, 2026

(54) METHOD FOR FORMING A CONFECTION

(71) Applicant: Intercontinental Great Brands LLC, East Hanover, NJ (US)

(72) Inventors: Ryan Caine, Parsippany, NJ (US); Bharat Jani, Brunswick, NJ (US); Lixin Han, East Hanover, NJ (US); William M. Polak, Budd Lake, NJ (US)

(21) Appl. No.: 19/469,073

(22) PCT Filed: Apr. 5, 2024
(86) PCT No.: PCT/US2024/023238

§ 371 Date: Sep. 25, 2025

Related U.S. Application Data
(60) Provisional application No. 63/494,939, filed on Apr. 7, 2023.
(60) Provisional application No. 63/617,561, filed on Jan. 4, 2024.

(51) Int. Cl. A23G 3/02

(52) U.S. Cl. CPC A23G 3/0226; A23G 3/0215; A23G 3/0242

(57) ABSTRACT

A method for forming a jelly confection includes providing a jelly confection material to a moisture removal system, continuously renewing an exterior surface of the jelly confection material via the moisture removal system, removing moisture from the jelly confection material via the moisture removal system, outputting the jelly confection from the moisture removal system, and forming the jelly confection material into a plurality of pieces of jelly confection.

### CROSS REFERENCE TO RELATED APPLICATIONS

This application claims the benefit of U.S. Application No. 63/494,939, filed on Apr. 7, 2023, and U.S. Application No. 63/617,561, filed on Jan. 4, 2024, which is incorporated herein by reference in its entirety.

### FIELD

The disclosure relates generally to a system and method for forming a confection, and more particularly to a system and method for forming a jelly confection.

### BACKGROUND

Jelly confection is typically formed using a stoving process, wherein a jelly slurry is deposited into cavities pressed into a starch-based slab. The starch-based slab with the jelly deposits is heated/cooked at 50° C. to 70° C. in an oven type environment for 30 to 70 hours. As the jelly deposits cook, moisture is removed and structure is created in the individual deposits to form jelly pieces. A skin that is less moisture diffusive than the remainder of the jelly deposits also forms about the surfaces of the deposits.

A more time efficient process for forming a jelly confection would be desirable. Avoiding formation of the above discussed skin would also be desirable.

### SUMMARY

According to an embodiment, a method for forming a jelly confection includes providing a jelly confection material to a moisture removal system, continuously renewing an exterior surface of the jelly confection material via the moisture removal system, removing moisture from the jelly confection material via the moisture removal system, outputting the jelly confection from the moisture removal system, and forming the jelly confection material into a plurality of pieces of jelly confection.

In addition to one or more of the features described above, or as an alternative, in further embodiments outputting the jelly confection material from an outlet of the moisture removal system. A percentage of solids of the jelly confection material at the outlet is greater than the percentage of solids when the jelly confection material is provided to the moisture removal system.

In addition to one or more of the features described above, or as an alternative, in further embodiments the jelly confection material at the outlet of the moisture removal system is a high solids jelly.

In addition to one or more of the features described above, or as an alternative, in further embodiments the jelly confection material provided to the moisture removal system is a low solids jelly.

In addition to one or more of the features described above, or as an alternative, in further embodiments mixing the jelly confection material within the moisture removal system.

In addition to one or more of the features described above, or as an alternative, in further embodiments the continuously renewing the exterior surface of the jelly confection material occurs via the mixing.

In addition to one or more of the features described above, or as an alternative, in further embodiments the moisture removal system is an extruder.

In addition to one or more of the features described above, or as an alternative, in further embodiments removing moisture from the jelly confection material occurs while the jelly confection material is within the extruder.

In addition to one or more of the features described above, or as an alternative, in further embodiments the extruder includes at least one devolatization section having at least one opening to an ambient environment. Removing moisture from the jelly confection material occurs via the at least one opening.

In addition to one or more of the features described above, or as an alternative, in further embodiments the at least one devolatization section includes a vacuum device in communication with the at least one opening. The vacuum device is positioned to actively pull moisture from the jelly confection material and the extruder.

In addition to one or more of the features described above, or as an alternative, in further embodiments the moisture removal system includes a mixer. The method includes outputting the jelly confection material from an outlet of the mixer. The percentage of solids of the jelly confection material at the outlet of the mixer is equal to the percentage of solids of the jelly confection material provided to the mixer.

In addition to one or more of the features described above, or as an alternative, in further embodiments the mixer is a scraped surface heat exchanger.

In addition to one or more of the features described above, or as an alternative, in further embodiments the moisture removal system includes a nozzle fluidly coupled to the mixer. The method includes providing the jelly confection material from the outlet of the mixer to the nozzle and releasing the jelly confection material from the nozzle.

In addition to one or more of the features described above, or as an alternative, in further embodiments the removing moisture from the jelly confection material occurs upon the releasing of the jelly confection material from the nozzle.

In addition to one or more of the features described above, or as an alternative, in further embodiments the removing moisture from the jelly confection material occurs in response to continuously renewing the exterior surface of the jelly confection material.

In addition to one or more of the features described above, or as an alternative, in further embodiments the jelly confection material is released from the nozzle into a low-moisture, low pressure environment.

In addition to one or more of the features described above, or as an alternative, in further embodiments heating the jelly confection material within the moisture removal system to a temperature of 95° C.-150° C.

In addition to one or more of the features described above, or as an alternative, in further embodiments adding at least one sensitive ingredient to the jelly confection material after the removing moisture from the jelly confection material.

In addition to one or more of the features described above, or as an alternative, in further embodiments during the continuously renewing the exterior surface of the jelly confection material, the jelly confection material has a consistent moisture diffusivity in a plane perpendicular to a flow direction of the jelly confection material.

According to an embodiment, a method of forming pieces of a jelly confection includes mixing a jelly confection material in a moisture removal system, outputting the jelly confection material from the moisture removal system, and forming the jelly confection material into a plurality of pieces of jelly confection having a three-dimensional shape using a forming station. The jelly confection material output from the moisture removal system is a high solids jelly.

In addition to one or more of the features described above, or as an alternative, in further embodiments the forming station includes at least one roller. The at least one roller has a plurality of cavities formed about a periphery thereof for receiving the jelly confection material.

In addition to one or more of the features described above, or as an alternative, in further embodiments forming the jelly confection material into the plurality of pieces of jelly confection having the three-dimensional shape includes compressing the jelly confection material into the plurality of cavities.

In addition to one or more of the features described above, or as an alternative, in further embodiments the at least one roller includes a first roller and a second roller. The first roller has a plurality of first cavities formed therein and the second roller has a plurality of second cavities formed therein.

In addition to one or more of the features described above, or as an alternative, in further embodiments the plurality of first cavities and the plurality of second cavities cooperate to form and size the jelly confection material into the three-dimensional shape.

In addition to one or more of the features described above, or as an alternative, in further embodiments the jelly confection material provided to the forming station has a uniform thickness.

In addition to one or more of the features described above, or as an alternative, in further embodiments extruding the jelly confection material at a location upstream from the forming station.

In addition to one or more of the features described above, or as an alternative, in further embodiments the jelly confection material provided to the forming station is unshaped.

In addition to one or more of the features described above, or as an alternative, in further embodiments forming the jelly confection material into the plurality of pieces of jelly confection having the three-dimensional shape includes compressing the jelly confection material into the plurality of first cavities and the plurality of second cavities. At least one of the plurality of first cavities is aligned with one of the plurality of second cavities.

According to an embodiment, a method of forming a jelly confection includes adding at least one particle having a dimension greater than 4 mm to a jelly confection material, mixing the jelly confection material in a moisture removal system, removing moisture from the jelly confection material within the moisture removal system, and outputting the jelly confection material from the moisture removal system.

In addition to one or more of the features described above, or as an alternative, in further embodiments mixing the jelly confection material encapsulates the at least one particle within the jelly confection material.

In addition to one or more of the features described above, or as an alternative, in further embodiments the at least one particle includes a plurality of particles and the mixing the jelly confection material uniformly distributes the plurality of particles within the jelly confection material.

In addition to one or more of the features described above, or as an alternative, in further embodiments adding the at least one particle having the dimension greater than 4 mm to the jelly confection material occurs upstream from at least a portion of the mixing the jelly confection material.

In addition to one or more of the features described above, or as an alternative, in further embodiments adding the at least one particle having the dimension greater than 4 mm to the jelly confection material occurs upstream from the mixing the jelly confection material.

In addition to one or more of the features described above, or as an alternative, in further embodiments adding the at least one particle having the dimension greater than 4 mm to the jelly confection material occurs after the removing moisture from the jelly confection material.

In addition to one or more of the features described above, or as an alternative, in further embodiments a jelly confection includes a jelly confection material that is a high solids jelly and at least one particle is encapsulated within the high solids jelly.

According to an embodiment, a method for forming a jelly confection includes providing a jelly confection material to a moisture removal system, removing moisture from the jelly confection material via the moisture removal system, forming the jelly confection material into a plurality of pieces, and adding at least one sensitive ingredient to the jelly confection material prior to forming the jelly confection material into the plurality of pieces.

In addition to one or more of the features described above, or as an alternative, in further embodiments adding the at least one sensitive ingredient occurs within the moisture removal system.

In addition to one or more of the features described above, or as an alternative, in further embodiments the moisture removal system is an extruder.

In addition to one or more of the features described above, or as an alternative, in further embodiments adding the at least one sensitive ingredient to the jelly confection material occurs after removing moisture from the jelly confection material.

In addition to one or more of the features described above, or as an alternative, in further embodiments the jelly confection material is provided having a first percentage of solids and after removing moisture from the jelly confection material, the jelly confection material has a second percentage of solids.

In addition to one or more of the features described above, or as an alternative, in further embodiments the jelly confection material provided to the moisture removal system is a low solids jelly.

In addition to one or more of the features described above, or as an alternative, in further embodiments the jelly confection material after removing moisture from the jelly confection material is a high solids jelly.

In addition to one or more of the features described above, or as an alternative, in further embodiments the at least one sensitive ingredient is added to the jelly confection material having the second percentage of solids.

According to an embodiment, a method for forming a jelly confection includes transforming a jelly confection material having a first percentage of solids into the jelly confection material having a second percentage of solids via a moisture removal system, forming the jelly confection material having the second percentage of solids into a desired shape, and recycling a portion of the jelly confection material.

In addition to one or more of the features described above, or as an alternative, in further embodiments the jelly confection material having the second percentage of solids is a high solids jelly.

In addition to one or more of the features described above, or as an alternative, in further embodiments the jelly confection material having the first percentage of solids is a low solids jelly.

In addition to one or more of the features described above, or as an alternative, in further embodiments outputting the jelly confection material having the second percentage of solids via an outlet of the moisture removal system. Recycling the portion of the jelly confection material includes returning at least some of the jelly confection material having the second percentage of solids output from the outlet of the moisture removal system to the moisture removal system.

In addition to one or more of the features described above, or as an alternative, in further embodiments the moisture removal system includes at least one devolatization section for removing moisture from the jelly confection material. The portion of the jelly confection material is returned to the moisture removal system at a location upstream from the at least one devolatization section.

In addition to one or more of the features described above, or as an alternative, in further embodiments forming the jelly confection material into the desired shape includes forming scraps of the jelly confection material.

In addition to one or more of the features described above, or as an alternative, in further embodiments recycling the portion of the jelly confection material includes recycling the scraps of the jelly confection material.

In addition to one or more of the features described above, or as an alternative, in further embodiments recycling the scraps of the jelly confection material includes providing the scraps of the jelly confection material to a manufacturing component that was not used to perform either the transforming the jelly confection material having the first percentage of solids into the jelly confection material having the second percentage of solids or the forming the jelly confection material into the desired shape.

In addition to one or more of the features described above, or as an alternative, in further embodiments the providing the scraps of the jelly confection material to the manufacturing component that was not used to perform either the transforming the jelly confection material having the first percentage of solids into the jelly confection material having the second percentage of solids or the forming the jelly confection material into the desired shape includes providing the scraps of the jelly confection material to an extruder.

According to an embodiment, a system for forming a jelly confection includes an extruder having an inlet for receiving a jelly confection material having a first percentage of solids, an outlet for expelling a jelly confection material having a second percentage of solids, a plurality of sections that cooperate to define a flow path extending between the inlet and the outlet, and at least one screw rotatable to move the jelly confection material along the flow path. The plurality of sections includes at least one devolatization section. The at least one devolatization section has an opening through which moisture from the jelly confection material is removed.

In addition to one or more of the features described above, or as an alternative, in further embodiments the second percentage of solids is greater than the first percentage of solids.

In addition to one or more of the features described above, or as an alternative, in further embodiments the opening is open to an ambient atmosphere surrounding the extruder.

In addition to one or more of the features described above, or as an alternative, in further embodiments including a vacuum device operably coupled to the opening.

In addition to one or more of the features described above, or as an alternative, in further embodiments at least one of the plurality of sections is a conveying section including a heating system.

In addition to one or more of the features described above, or as an alternative, in further embodiments the conveying section including the heating system is located upstream from the at least one devolatization section relative to the flow path.

In addition to one or more of the features described above, or as an alternative, in further embodiments including another inlet for receiving sensitive ingredients. The another inlet is arranged downstream of the at least one devolatization section.

In addition to one or more of the features described above, or as an alternative, in further embodiments the at least one devolatization section includes a plurality of devolatization sections and the another inlet is arranged downstream of all of the plurality of devolatization sections.

According to an embodiment, a system for forming a jelly confection includes a mixer having an inlet for receiving a jelly confection material having a first percentage of solids and a nozzle fluidly coupled to the mixer. An environment adjacent to an outlet of the nozzle is at least one of low pressure and low moisture.

In addition to one or more of the features described above, or as an alternative, in further embodiments the mixer is a scraped surface heat exchanger.

In addition to one or more of the features described above, or as an alternative, in further embodiments including at least one containment device positioned vertically underneath and fluidly coupled to the outlet of the nozzle.

In addition to one or more of the features described above, or as an alternative, in further embodiments the jelly confection material output from the outlet of the nozzle is configured to fall into the at least one containment device.

In addition to one or more of the features described above, or as an alternative, in further embodiments the jelly confection material output from the outlet of the nozzle has the first percentage of solids.

In addition to one or more of the features described above, or as an alternative, in further embodiments the jelly confection material receivable within the at least one containment device has a second percentage of solids. The second percentage of solids is greater than the first percentage of solids.

In addition to one or more of the features described above, or as an alternative, in further embodiments the at least one containment device includes a first containment device and a second containment device. The second containment device is positioned downstream from the first containment device.

In addition to one or more of the features described above, or as an alternative, in further embodiments the jelly confection material receivable within the second containment device has a second percentage of solids. The second percentage of solids is greater than the first percentage of solids.

In addition to one or more of the features described above, or as an alternative, in further embodiments the mixer includes a heating system.

### BRIEF DESCRIPTION OF THE DRAWINGS

The accompanying drawings incorporated in and forming a part of the specification embodies several aspects of the present disclosure and, together with the description, serves to explain the principles of the present disclosure. In the drawings:

FIG. 1 is a schematic of a system for forming a jelly confection according to an embodiment;

FIG. 2 is a schematic cross-sectional view of an extruder for use in the system for forming a jelly confection according to an embodiment;

FIG. 3 is a block diagram illustrating a method for forming a jelly confection according to an embodiment;

FIG. 4 is a schematic diagram of a moisture removal system including a scraped surface heat exchanger for forming a jelly confection according to an embodiment;

FIG. 4A is a schematic view of a containment device of the moisture removal system of FIG. 4 according to an embodiment;

FIG. 5 is a view of a plurality of containment devices of the moisture removal system arranged in series according to an embodiment;

FIG. 6 is a block diagram illustrating a method for forming a jelly confection according to another embodiment;

FIG. 7 is a schematic diagram of manufacturing equipment operable to process a final jelly confection material into a plurality of pieces; and

FIG. 8 is a detailed schematic view of a pair of rollers of a forming station operable to simultaneously size and shape the final jelly confection material.

### DETAILED DESCRIPTION

Embodiments disclosed herein related to a system and method of forming a jelly. As used herein, the term “jelly” is intended to describe a confection containing various sugars and water, as well as at least one of a boiled starch, pectin, gelatin, and similar hydrocolloids. Jelly may also contain one or more of a color, flavor, and food acids. Furthermore, a jelly may transform between various stages during the forming process. Examples of these stages include a low solids jelly, a high solids jelly, and a stable high solids jelly are discussed herein. As used herein the phrase “low solids jelly” is intended to describe a jelly having a percentage of solids less than 80%, and in some embodiments less than 78%. In some embodiments, the percentage of solids of a low solids jelly is typically between about 72% and about 78% for example. As used herein the phrase “high solids jelly” is intended to describe a jelly having a percentage of solids greater than 78%, and in some embodiments, greater than 80% (and greater than the percentage of solids associated with the low solids jelly). In some embodiments, the percentage of solids of a high solids jelly is typically between about 82% and about 90% for example. As used herein the phrase “stable high solids jelly” is intended to describe a high solids jelly after conditioning of the jelly has occurred. After conditioning, which typically includes intentional cooling of the jelly, the jelly has a shape that is stable at room temperature.

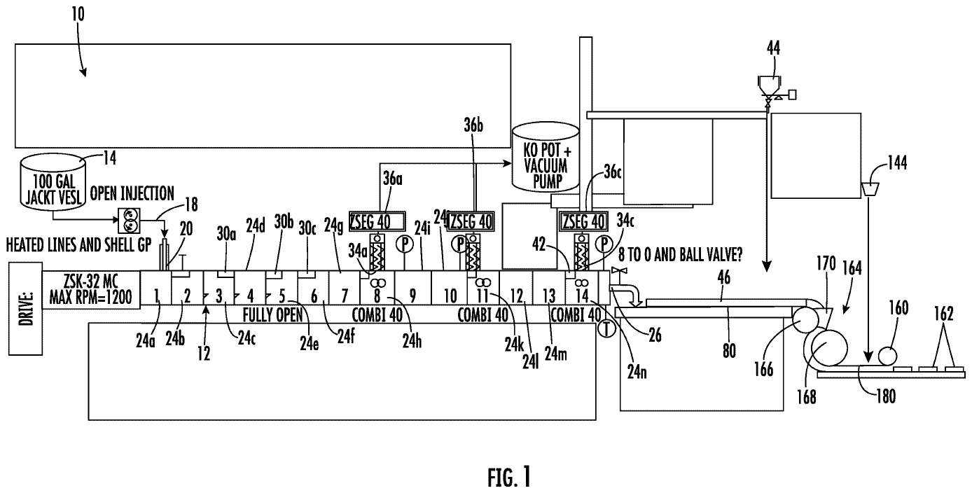

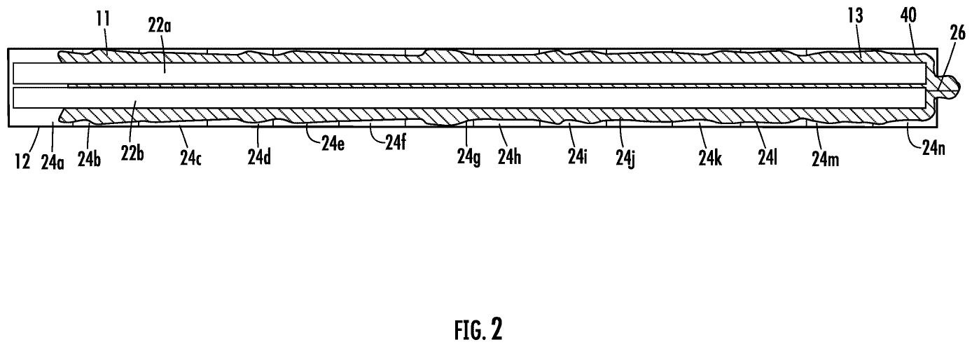

With reference to FIGS. 1 and 2, an example of a system 10 for forming a jelly confection from a jelly confection material is shown. As will be discussed herein, the system for forming the jelly confection includes a moisture removal system 12. As will be described in more detail below, the moisture removal system 12 may be any device or combination of devices capable of continuously mixing or stirring the jelly confection material, and in some embodiments, simultaneously heating and continuously mixing or stirring the jelly confection material. In the illustrated, non-limiting embodiment of FIGS. 1 and 2, the moisture removal system 12 is an extruder. As shown, a jelly confection material 11 having a first set of properties is provided as an input to the extruder 12 and is processed within the extruder 12 into a jelly confection material 13 having a second set of properties. The first set of properties may include a first percentage of solids, and the second set of properties may include a second percentage of solids. In an embodiment, as will be described in more detail below, the jelly confection material 11 having the first set of properties is a low solids jelly and the jelly confection material 13 having the second set of properties is a high solids jelly. However, it should be appreciated that in other embodiments, the jelly confection material 11 provided to the extruder 12 as an input and the jelly confection material 13 output from the extruder 12 may both be low solids jellies or high solids jellies, with the percentage of solids of the jelly confection material 13 output from the extruder 12 being greater than the percentage of solids of the jelly confection material 11 input to the extruder 12.

In an exemplary embodiment, the system 10 for processing the jelly confection material includes a jelly supply 14 (such as but not limited to a batch mixer or tank) that supplies the extruder 12 with the jelly confection material 11 having the first set of properties, for example a low solids jelly. In an embodiment, the jelly confection material 11 is a slurry or solution. As shown in the Figures, the jelly confection material 11 is delivered from the jelly supply 14 to the extruder 12 via a jelly conveyance, such as but not limited to an injection line 18 that provides low solids jelly to the extruder 12 at a jelly input 20 thereof. The injection line 18 may be heated to allow for a more flowable viscosity of the jelly confection material 11 as it travels through the injection line 18 to the extruder 12. It should be understood that the jelly confection material 11 may additionally or alternatively be provided to the extruder 12 via a side feed, hopper, or any other known method for supplying slurry material or solution to an extruder.

The jelly confection material 11 provided by the jelly supply 14 to the extruder 12, such as a low solids jelly for example, may include all jelly ingredients except certain temperature sensitive ingredients or shearing sensitive ingredients, such as flavoring and perhaps comestible pieces such as dried crumble. Low solids jelly, absent the referenced sensitive ingredients, may include ingredients such as but not limited to water, glucose, invert sugar, granular sugar, starch, and pectin. As will be discussed in more detail below, at least one temperature sensitive ingredient or shearing sensitive ingredient may be added to the extruder 12 at one or more downstream sections thereof. Such sensitive ingredients include but are not limited to prebiotics, probiotics, vitamins, flavors, and colors. Comestible pieces such as but not limited to pieces such as nuts, dried fruit, pieces of baked goods, and pieces of candy for example, may also be added at downstream sections of the extruder 12, or after the jelly confection material 13 is output from the extrusion point 26 of the extruder 12.

The extruder 12 in the system 10 may be any type of continuous extruder, such as but not limited to a single screw, twin screw, or planetary roller extruder. In the exemplary embodiment of FIGS. 1 and 2, the extruder 12 is a twin screw extruder including a first screw 22a that is either proximate or intermeshing with a second screw 22b. The twin screw extruder 12 may include a plurality of sections or barrels 24a-n or a single barrel having a plurality of zones that may be used for a plurality of different extrusion or processing functions. An exemplary method for processing a jelly confection material 11 into a jelly confection material 13 to be output from the extruder 12 using the twin screw extruder 12 will be described hereinbelow.

As is noted above, a jelly confection material 11 is provided to the extruder 12 from the jelly supply 14. The jelly confection material 11 provided at the input 20 of the first section 24a has or contains a first percentage of solids. In an exemplary embodiment, the first percentage of solids is between about 70%-80% solids, and more particularly about 71%, 72%, 73%, 74%, 75%, 76%, 77%, 78%, 79% or 80% solids. Accordingly, in an embodiment, the jelly confection material 11 having the first percentage of solids is a low solids jelly. The remaining percentage of the low solids jelly 11, may but need not be water or another liquid. Via the mixing and conveying processes that occurs between the input 20 and exit/extrusion point 26 of the extruder 12, the jelly confection material 11 is “de-watered” to form a jelly confection material 13 having a desired second percentage of solids. In an exemplary embodiment, the second percentage of solids associated with the jelly confection material 13 is between about 81%-95% solids, and more particularly about 81%, 82%, 83%, 84%, 85%, 86%, 87%, 88%, 89%, 90%, 91%, 92%, 93%, 94% or 95% solids. Accordingly, in an embodiment, the jelly confection material 13 having the second percentage of solids is a high solids jelly. As previously noted, although this de-watering process or moisture reduction is described with respect to transforming a low solids jelly confection material 11 into a high solids jelly confection material 13, in other embodiments, the process may be used to simply increase the percentage of solids within a low solids jelly or within a high solids jelly, respectively. In the exemplary embodiment shown in FIGS. 1 and 2, this de-watering or moisture reduction occurs as follows.

The first section 24a of the extruder 12 is raw material/slurry entry section. The jelly confection material 11 may be provided to the first section 24a in any suitable manner, including but not limited to via an injection line, a hopper, or even a hole formed in the first section 24a. This section is typically not heated, though in some embodiments, it may be, such as when the jelly confection material 11 provided thereto is at a relatively heated temperature upon entry into the section 24a. For example, the jelly confection material 11 in the form of a low solids jelly may be provided to the first section 24a with a temperature equal to or greater than 90° C. From here, the low solids jelly 11 is moved as a result of the rotating screw geometry downstream to the second section 24b. In the exemplary embodiment of FIGS. 1 and 2, the extruder 12 is a twin screw extruder, and the screw geometry is provided by the two screws 22a, 22b. In an exemplary embodiment employing an extruder with twin screws, the rotating screws 22a, 22b continuously move the low solids jelly 11 through a flow path of the extruder defined by each of the successive barrels or sections 24a-n in combination, all the way to the output or extrusion point 26.

For ease of understanding, the jelly confection material is generally represented by numeral 11 as it flows through the extruder 12 until becoming a jelly confection material 13 having the second percentage of solids. However, it should be understood that the percentage of solids of the jelly confection material 11 gradually increases from the first percentage of solids to the second percentage of solids within the extruder 12. Accordingly, the jelly confection material arranged at a position of the extruder 12 between the inlet and the location where the jelly confection material reaches the second percentage of solids J2, although referred to as jelly confection material 11, has a percentage of solids between the first percentage and the second percentage of solids, respectively.

Like a number of the sections of the extruder 12 shown in the exemplary embodiment of FIGS. 1 and 2, the first and second section 24b are typically conveying sections where the jelly confection material 11 is moved downstream, mixed, and in some embodiments, is heated via an extruder heating system. In such an extruder, at least one conveying section, like section 24b typically heats the jelly confection material 11 to a temperature between about 95° C. and 150° C., such as between about 95° C. and 145° C., between about 95° C. and 140° C., between about 95° C. and 135° C., between about 95° C. and 130° C., between about 95° C. and 125° C., between about 95° C. and 120° C., between about 100° C. and 150° C., between about 100° C. and 145° C., between about 100° C. and 140° C., between about 100° C. and 135° C., between about 100° C. and 130° C., between about 100° C. and 125° C., between about 100° C. and 120° C., between about 105° C. and 150° C., between about 105° C. and 145° C., between about 105° C. and 140° C., between about 105° C. and 135° C., between about 105° C. and 130° C., between about 105° C. and 125° C., between about 105° C. and 120° C., between about 110° C. and 150° C., between about 110° C. and 145° C., between about 110° C. and 140° C., between about 110° C. and 135° C., between about 110° C. and 130° C., between about 110° C. and 125° C., between about 110° C. and 120° C., between about 115° C. and 150° C., between about 115° C. and 145° C., between about 115° C. and 140° C., between about 115° C. and 135° C., between about 115° C. and 130° C., between about 115° C. and 125° C. or between about 115° C. and 120° C. In an embodiment, the heated moisture within the jelly confection material 11 remains a liquid within the second section 24b.

From the second section 24b, the jelly confection material 11 is conveyed by the screws 22a, 22b to the third section 24c. In the exemplary embodiment shown in FIGS. 1 and 2 the third section 24c is the first devolatization barrel or section, wherein moisture, such as vaporized moisture, is removed from the jelly confection material 11 to at least begin the increase in solid percentage thereof to raise from the first percentage of solids to the second percentage of solids as discussed above. Of course, although the exemplary embodiment discussed herein describes the third section 24c as the first devolatization barrel or section, it should be appreciated that any section of the extruder 12 may be configured as a devolatization section.

In an embodiment, a single barrel or section, such as the third section 24c for example, is the only devolatization or moisture removing section of the extruder 12. In such embodiments, the amount of moisture removed within the only devolatization section is sufficient to transform the jelly confection material 11 having the first percentage of solids to the jelly confection material 13 having an elevated second percentage of solids and that will eventually be output from the extruder 12. In other embodiments, the section 24c is one of a plurality of devolatization sections arranged along the extruder 12, as is the case in the exemplary embodiment of FIGS. 1 and 2, wherein moisture may be removed in a consistent manner (for example, the solid percentage increases by 2% in each successive devolatization barrel or section), or an inconsistent manner (for example, the solid percentage increases by a different percentage in in each successive devolatization barrel or section).

In an embodiment, the devolatilization section has a free volume therein which is at or slightly above atmospheric pressure (in embodiments where a vacuum device is not connected thereto). The depressurization of the devolatization section may occur as a result of the configuration of the one or more screws of the extruder 12. In an embodiment, the at least one screw of the extruder 12 is configured to pull the jelly confection material 11 from the devolatization section faster than the jelly confection material 11 is provided to the devolatization section.

Like the conveying sections such as second section 24b, the at least one devolatization section, such as third section 24c for example, may also include a heating system to heat the jelly confection material 11 to a temperature of about 105° C.-135° C., such as between about 105° C. and 130° C., between about 105° C. and 125° C., between about 105° C. and 120° C., between about 110° C. and 135° C., between about 110° C. and 130° C., between about 110° C. and 125° C., between about 110° C. and 120° C., between about 115° C. and 135° C., between about 115° C. and 130° C., between about 115° C. and 125° C. or between about 115° C. and 120° C., or between about 125° C.-130° C. to convert or maintain the moisture of the jelly confection material 11 as a vapor. In an embodiment, substantially all or the majority of vaporization of the moisture within the jelly confection material 11 occurs within the at least one devolatization section. As the moisture at the surface of the jelly confection material 11 facing the free volume is heated, the moisture vaporizes and flows into the free volume. As a result of the rotation of the screws, a new surface of the jelly confection material 11 is continuously exposed to the free volume, resulting in a continuous release of vaporized moisture from the jelly confection material 11. In this manner, the vaporized moisture does not need to pass through the jelly confection material 11 to escape into the free volume.

It should be noted that the third section 24c illustrated in the exemplary embodiment of FIGS. 1 and 2 is a first type of devolatization section that simply includes at least one opening to the ambient environment in a wall of the extruder 12, such as opening 30a, which allows at least some of the vaporized moisture within the devolatization section to escape from the jelly confection material 11 and the extruder 12. The fifth and sixth sections 24e and 24f are also the first type of devolatization barrel sections with openings 30b and 30c, respectively. Like the third section 24c, these sections 24e and 24f may also include a heating system to heat the jelly confection material 11 to a temperature of about 105° C.-135° C., and more particularly to about 110° C.-120° C. or to about 125° C.-130° C. to heat the moisture as discussed above, with the openings 30b and 30c likewise allowing the vapor moisture to escape therethrough. However, it should be appreciated that each devolatization section may have a different temperature profile. Further, the devolatization sections need not have the same temperature profile as the conveying sections.

As shown in the exemplary embodiment of FIGS. 1 and 2, the jelly confection material 11 is conveyed along a downstream path of the extruder 12 from the third section 24c to the fourth section 24d. The fourth section 24d is a conveying and heating section like the second section 24b. From the fourth section 24d, the jelly confection material 11 is conveyed via the screws 22a, 22b to fifth and sixth sections 24e and 24f, which, as discussed above, function as a first type of devolatization sections. The jelly confection material 11 is then moved on its downstream path to a seventh section 24g, which is another conveying and heating section like sections 24b and 24d. From the seventh section 24g the jelly confection material 11 is conveyed via the screws 22a, 22b to the eighth section 24h, which functions as a second type of devolatization section, which will be discussed in greater detail below with reference to eleventh section 24k. Ninth and tenth sections 24i and 24j are located downstream of section 24h and may function as conveying and heating sections like sections 24b, 24d, and 24g.

From the tenth section 24j, the jelly confection material 11 is conveyed via the screws 22a, 22b to the eleventh section 24k, which, like section 24h and in accordance with the exemplary embodiment of FIGS. 1 and 2, is a second type of devolatization section. In a second type of devolatization section as discussed herein, instead of simply including an opening to ambient like the first type of devolatization sections, the second type of devolatization sections (such as sections 24h and 24k) include respective openings 34a, 34b coupled to one or more vacuum devices 36a, 36b. Although a different vacuum device is illustrated as being coupled to each respective opening 34a, 34b, embodiments where multiple sections configured as a second type of devolatization section are fluidly coupled to the same vacuum device are also within the scope of the disclosure. The one or more vacuum devices 36a, 36b are operable to actively pull the vaporized moisture from the free volume of a second type devolatization section of the extruder 12. In an exemplary embodiment, these vacuum devices 36a, 36b remove moisture from the devolatization sections through the respective openings 34a, 34b. The pressure resulting from application of the vacuum devices may be anywhere from atmospheric pressure up to a full vacuum (zero pressure). The application of a vacuum device 36a, 36b to the second devolatization sections may increase the rate of evaporation and moisture removal from the jelly confection material 11 within these sections.

As discussed above, the second type of devolatization barrel sections like section 24h, 24k may remove an amount of moisture that creates an increase in solid percentage that is the same as the increase found in the first type of devolatization sections. Indeed, even though the vacuum devices 36a, 36b create a more active removal of moisture than that found in the first type devolatization sections, the percentage of solids of the jelly confection material 11 may increase at the same rate due to the reduced presence of moisture at the downstream location of the vacuum devices 36a, 36b relative to the upstream location of the openings 30a-d in the first type devolatization sections. This is the case in the exemplary embodiment of FIGS. 1 and 2. Of course, the vacuum devices associated with the second type of devolatization sections like sections 24h, 24k may also increase the percentage of solids in the jelly confection material 11 at a greater rate than the first type of devolatization sections, or may simply be modifiable to remove moisture at any level that achieves any desired increase in rate.

In the exemplary embodiment of FIGS. 1 and 2 there are two more conveying and heating sections downstream of eleventh section 24k. These two conveying and heating sections 24l and 24m function like sections 24b, 24d, 24g, 24i, and 24j. Section 24n is the fourteenth and last section as shown in the exemplary embodiment of FIGS. 1 and 2. This section 24n includes opening 34c and vacuum device 36c, and functions as a second type devolatization section like section 24k. Section 24n is an output section including the extrusion point 26 of the extruder 12, from which the jelly confection material 13, such as in the form of a high solids jelly for example, is output. As such, in the exemplary embodiment of FIGS. 1 and 2 it is in the final section 24n of the extruder 12 where moisture has been removed to a point where the low solids jelly 11 is transformed into the high solids jelly having the desired second percentage of solids (or final percentage of solids for the resultant jelly confection) as discussed above. It should be appreciated that in some embodiments, the jelly confection material within the moisture removal system 12 transforms from the jelly confection material 11 having the first percentage of solids to the jelly confection material 13 having the second percentage of solids at a location upstream from the final devolatilization section.

Some additional, unintentional devolatization or further moisture removal may occur at the outlet or extrusion point 26 of the extruder 12, when the jelly confection material 13 exits from the extruder die. Accordingly, in embodiments where the outlet 26 of the extruder 12 is arranged downstream from the final devolatization section, the outlet 26 may be the final location where moisture is removed from the jelly confection material to form the jelly confection material 13 having the second percentage of solids. In an embodiment, the extruder outlet is connected to a constrained pipe (not shown). In such embodiments, final devolatization may occur as the jelly confection material 13 passes through the outlet end of the constrained pipe.

The extruder 12 is described above with reference to an exemplary number of barrels or sections 24a-n as shown in FIGS. 1 and 2. However, this is merely an example of a system that may be used. The extruder 12 can include any number of barrels or sections in any suitable arrangement. For example, the extruder 12 may include an entry section, and downstream exit section, and any number of mixing sections, conveying sections, first type of devolatization sections, and second type of devolatization sections therebetween. Further, it should be appreciated that the one or more conveying sections, first type of devolatization sections, and second type of devolatization sections may be arranged in any suitable order along the extruder 12. The entry section and exit sections may also function as conveying sections and/or devolatization sections (first or second type), with any number of sections that function as one or both of conveying sections and devolatization sections being disposed therebetween (including no sections therebetween). Further, it should be appreciated that any of the sections positioned between the entry section and the exit section may be capable of heating or cooling the jelly confection material disposed therein. Conveying sections and devolatization sections of the first or second type may be disposed upstream and downstream of each other in between the entry and exit sections of the extruder 12. Further, the jelly confection material 11 having the first percentage of solids may be transformed to the jelly confection material 13 having a desired second percentage of solids at any point along the extruder 12 following conveyance through some devolatization section, with the jelly confection material 13 being simply moved/conveyed to the exit section for extrusion without further devolatization (or further devolatization of any significance prior to exit/extrusion from extruder.)

To this point, the percentage of solids aspect of the jelly confection material 11 and the jelly confection material 13 has been discussed in some detail. The jelly confection material 13 having the second percentage of solids, such as a high solids jelly for example, may have a solids content and composition substantially identical to that of the final jelly confection with only sensitive ingredients and/or crumble being optionally added to the surface of the jelly confection material 13 once extruded. However, some other occurrences that may take place in or downstream from the extruder 12 may contribute to the production of a final jelly confection material used to form the final jelly confection. It should be appreciated that any suitable ingredients may be added to the jelly confection material at any location within or external to the moisture removal system 12.

For example, ingredients sensitive to one or more of temperature, shear, and volatility, also referred to herein as “sensitive ingredients” such as but not limited to those discussed above may optionally be added to the jelly confection material 13, such as within the extruder 12 via an inlet other than inlet 20. When added within the extruder 12, the at least one sensitive ingredient may be added at a location downstream from the formation of the high solids jelly or the jelly confection material 13 having the desired second percentage of solids, such as within a final conveying section of the extruder 12 for example. In an embodiment, the addition of sensitive ingredients within the extruder 12 occurs downstream of all devolatization of the jelly confection material 11. For example, any volatile sensitive ingredients should be added downstream from the final devolatization section to maintain the integrity of those ingredients. Any sensitive ingredients added at or upstream from a devolatization section should be non-volatile to prevent disappearance of some of the flavor within a devolatization section. Alternatively, or in addition, one or more sensitive ingredients may be added to the jelly confection material 13 downstream from the final conveying section, and/or the outlet 26 of the extruder 12, such as within a constrained pipe fluidly coupled to the outlet of the extruder 12 for example. These ingredients may be mixed with the jelly confection material 13 having a desired second percentage of solids via any suitable mechanism including, but not limited to a static mixer or a dynamic mixer. Accordingly, depending on the composition of the jelly confection being formed, the jelly confection material 13, the jelly confection material 13 including sensitive temperature ingredients, or the jelly confection material 13 including both sensitive ingredients and a topping may be considered a final jelly confection material.

At least one large particle or inclusion, such as having at least one dimension greater than 4 mm for example, may be incorporated into, such as embedded or encapsulated within the jelly confection material. Examples of such inclusions include but are not limited to pieces of fruit, nut, candy, baked pieces, and flavor particles. These large particles may be added within the extruder 12 either prior to the occurrence of all devolatization, such as to the jelly confection material 11 having the first percentage of solids for example, or after all devolatization has occurred, such as to the jelly confection material 13 having the second percentage of solids for example. In an embodiment, when added to the extruder 12, the at least one type of particles are added at any location upstream from or at the last barrel where mixing of the ingredients occurs, to ensure mixing and generally even distribution of the particles within the jelly confection material 11 or jelly confection material 13. Alternatively, or in addition, such large particles may be incorporated into the jelly confection material 11 prior to entering the extruder 12.

A jelly confection formed via traditional depositing and stoving methods could not include such large particles. In traditional stoving methods, a low solids jelly in the form of a jelly slurry is deposited into a plurality of molds formed in a tray via a depositing nozzle. The size of the depositing nozzle is selected to control the flow into each mold to prevent overfilling thereof. As a result, the small diameter of the depositing nozzle prevents the inclusion of large particles within the jelly slurry because such particles would get caught within and would ultimately clog the nozzle.

In traditional stoving methods, the heat directed to a surface of the low solids jelly to assist with devolatization creates a surface “skin” (an area of different diffusivity, typically less, than the remainder of the mixture) around at least a portion of the resultant jelly confection. This surface skin typically has a moisture diffusivity that may be two orders of magnitude lower than the moisture diffusivity of the remainder of the jelly confection. This low moisture diffusivity at the surface is one of the main reasons why the jelly confection material must be heated for an extended period of time to form a jelly confection having a desired percentage of solids.

Since the screws 22a, 22b of the extruder 12 are continuously rotating as the jelly confection material 11 is conveyed through the extruder 12, a new portion of the jelly confection material 11 is continually brought to the surface. This continuous renewal of the surface of the jelly confection material 11 or the jelly confection material 13 is particularly important within the at least one devolatization section. It is this constant exposure of a new portion of the jelly confection material 11 to the free volume within the at least one devolatization section that allows the moisture at the surface of the jelly confection material 11 to vaporize and be removed therefrom. It should be appreciated that during the de-watering or moisture removal process, the percentage of solids of the jelly confection material 11 may transform from a low solids jelly to a high solids jelly prior to becoming the jelly confection material 13 having the desired second percentage of solids.

A skin as described with respect to the traditional stoving process will not be formed within the extruder 12 because the surface of the jelly confection material 11 is continually renewed as the jelly confection material flows through the moisture removal system 12, and particularly through the one or more devolatization sections. Further, it should be noted that the jelly confection material 11 present within the extruder 12 may include a material composition with a consistent moisture diffusivity across an entire cross-sectional area thereof, such as taken in a plane perpendicular to a flow direction of the jelly confection material. Indeed, a generally consistent moisture diffusivity across an entire cross-sectional area will not only be present in the jelly confection material 13 at the outlet 26 of the extruder 12 but also in the jelly confection material 11 throughout a residence time within the extruder 12 due to the above discussed mixing and surface renewal.

In an exemplary embodiment, the jelly confection material 11 (in the form of a low solids jelly and in some embodiments a high solids jelly) has a residence time in the extruder 12 from input to extrusion of between about thirty seconds and about five minutes, such as less than four minutes, less than three minutes, less than two minutes, less than one minute, between about one minute and about four minutes, between about one minute and about three minutes, or between about one minute and about two minutes. Further, one or more of the screws 22a, 22b of the extruder 12 has an axial length L measured parallel to the axis of rotation of the one or more screws between the inlet and the extrusion point and has an internal diameter D. A ratio of the length to the diameter L/D may be at least 3:1, or in other embodiments, at least 4:1, 5:1, 6:1, 7:1, 8:1, 9:1, 10:1. In some embodiments, the ratio of the length to the diameter L/D may be at least 10:1, and in some embodiments is between 12:1 and 20:1, such as 12:1, 13:1, 14:1, 15:1, 16:1, 17:1, 18:1, 19:1, and 20:1. Further, in an embodiment, rotational speed of the one or more screws of the extruder may is between about 25rpm and about 500 rpm.

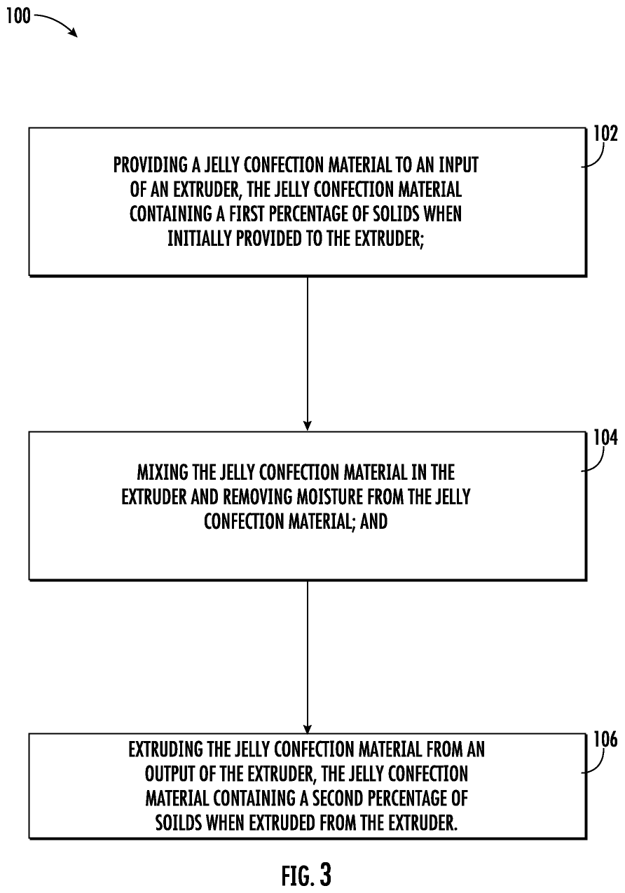

Referring now to FIG. 3, a block diagram depicting a method 100 for forming a jelly confection is shown. As shown in block 102, the method 100 includes providing a jelly confection material to an input of an extruder 12. The jelly confection material 11 may be a low solids jelly containing a first percentage of solids when initially provided to the extruder 12. As shown in block 104, the method 100 additionally includes mixing the jelly confection material 11 in the extruder 12 and removing moisture therefrom. Lastly, as shown in block 106, the method 100 further includes extruding the jelly confection material 13 from an outlet of the extruder 12. The jelly confection material 13 may be a high solids jelly 13 containing a second percentage of solids when extruded from the extruder 12.

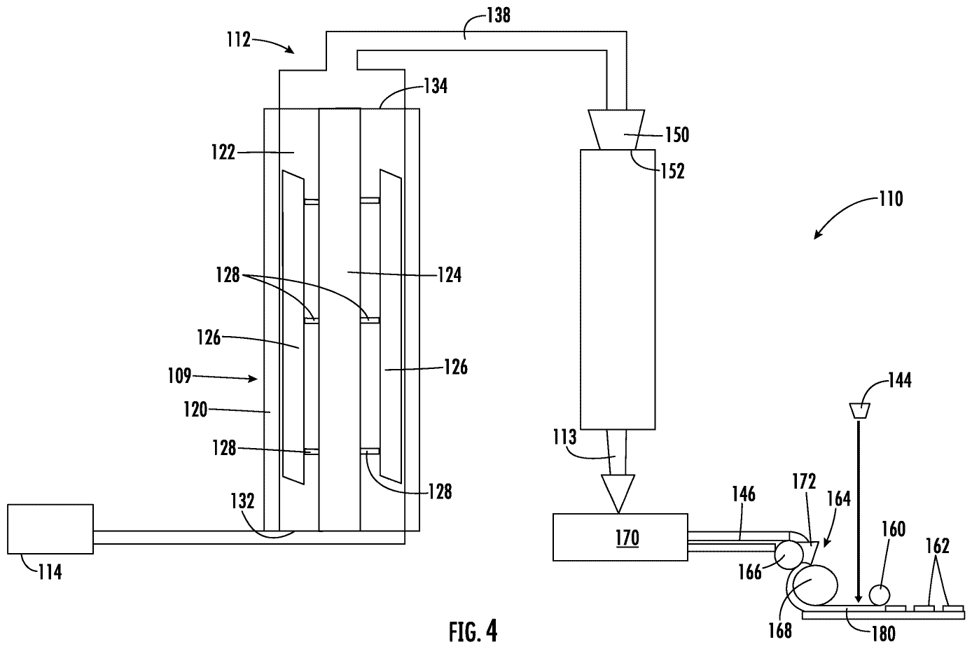

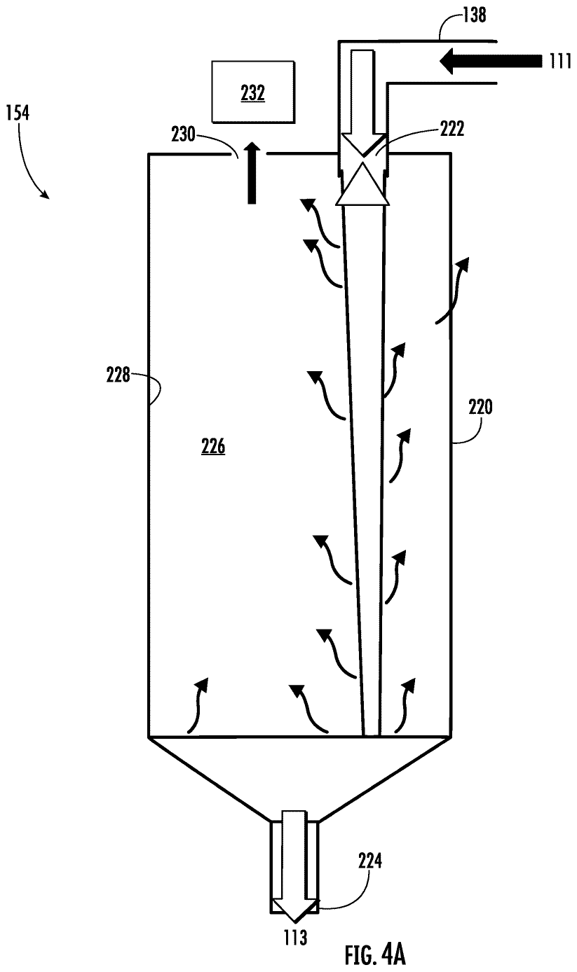

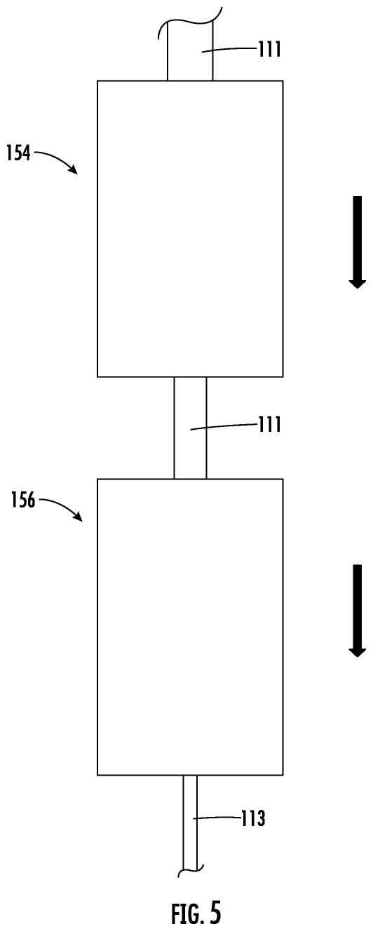

With reference now to FIGS. 4-5, an example of another moisture removal system 110 for forming a jelly confection is illustrated. As shown, the moisture removal system 110 includes a heating system 112 having a scraped surface heat exchanger 109. Although the scraped surface heat exchanger 109 is illustrated in a substantially vertical orientation, it should be understood that embodiments where the scraped surface heat exchanger 109 has another configuration, such as a horizontal configuration for example, are also within the scope of the disclosure. As shown, the scraped surface heat exchanger 109 includes a hollow cylindrical outer shell 120 surrounding an annular passage 122. A rotor 124 is located centrally within the interior of the annular passage 122 and includes one or more blades 126 extending outwardly from the rotor 124 via arms 128. As the rotor 124 rotates within the annular passage 122 about an axis, the interior surface 130 of the annular passage 122 is continuously engaged and “scraped” by the at least one blade 126 extending from the rotor 124.

A jelly confection material 111 having a first percentage of solids is provided to the annular passage 122 of the scraped surface heat exchanger 109. In an embodiment, the jelly confection material 111 is delivered to an inlet 132 of the annular passage 122, such as from a jelly confection material supply 114. Although the inlet 132 is illustrated as being arranged at a first, lower end of the scraped surface heat exchanger 109, it should be appreciated that in other embodiments, the inlet 132 may be located at another position about the scraped surface heat exchanger 109. Similar to the previous embodiment described above, the jelly confection material 111 provided to the scraped surface heat exchanger 109 may be a low solids jelly containing a first percentage of solids between 70%-80% solids, and more particularly 71%, 72%, 73%, 74%, 75%, 76%, 77%, 78%, or 79% solids. The remaining percentage of the jelly confection material 111 provided to the scraped surface heat exchanger 109, may but need not be water or another liquid moisture.

As the jelly confection material 111 flows through the annular passage 122 towards an outlet 134, such as arranged at a second opposite end of the scraped surface heat exchanger 109 for example, the jelly confection material 111 is heated. In an embodiment, a heat exchange medium M, such as water, air, oil, or another suitable medium, is circulated within the outer shell 120. Heat from the heat exchange medium M is transferred through the wall of the outer shell 120 to the jelly confection material 111. In an embodiment, the amount of heat transferred to the jelly confection material 111 within the scraped surface heat exchanger 109 is controlled such that the jelly confection material 111 at the outlet 134 has a temperature equal to or greater than the boiling point of water (at standard temperature and pressure). Further, the temperature of the jelly confection material 111 may be above the melt temperature to prevent the crystallization of the sugar within the jelly confection material 111 and the formation of a skin as previously described. In an embodiment, the jelly confection material 111 at the outlet 134 has a temperature between 95° C.-150° C., such as between about 95° C. and 145° C., between about 95° C. and 140° C., between about 95° C. and 135° C., between about 95° C. and 130° C., between about 95° C. and 125° C., between about 95° C. and 120° C., between about 100° C. and 150° C., between about 100° C. and 145° C., between about 100° C. and 140° C., between about 100° C. and 135° C., between about 100° C. and 130° C., between about 100° C. and 125° C., between about 100° C. and 120° C., between about 105° C. and 150° C., between about 105° C. and 145° C., between about 105° C. and 140° C., between about 105° C. and 135° C., between about 105° C. and 130° C., between about 105° C. and 125° C., between about 105° C. and 120° C., between about 110° C. and 150° C., between about 110° C. and 145° C., between about 110° C. and 140° C., between about 110° C. and 135° C., between about 110° C. and 130° C., between about 110° C. and 125° C., between about 110° C. and 120° C., between about 115° C. and 150° C., between about 115° C. and 145° C., between about 115° C. and 140° C., between about 115° C. and 135° C., between about 115° C. and 130° C., between about 115° C. and 125° C. or between about 115° C. and 120° C., or between about 125° C.-130° C.

As the jelly confection material 111 is heated, the rotation of the rotor 124 and resulting scraping of the interior surface 130 of the annular passage 122 continually mixes the jelly confection material 111, for example the low solids jelly. This mixing facilitates uniform heating of the jelly confection material 111. Although the jelly confection material 111 is heated within the scraped surface heat exchanger 109, the first percentage of solids of the jelly confection material 111 provided at the outlet 134 thereof may be substantially identical to that of the jelly confection material 111 provided to the inlet 132 of the scraped surface heat exchanger 109. Accordingly, the first percentage of solids of the jelly confection material 111 may remain generally constant as the jelly confection material 111 is heated within the scraped surface heat exchanger 109. Further, it should be appreciated that embodiments using another machine or device capable of heating the jelly confection material 111, and in some embodiments simultaneously heating and continuously mixing or stirring the jelly confection material 111 in place of the scraped surface heat exchanger, is within the scope of the disclosure. Examples of such a heat transfer device include but are not limited to a coil cooker and a heat exchanger, and in such embodiments, the jelly confection material 111 may be configured to move or flow continuously through the heat transfer device such that the jelly confection material 111 has with a non-laminar flow, and in some embodiments does not have boundary layers.

With continued reference to FIG. 4 and further reference to FIG. 4A, the moisture removal system 110 additionally includes at least one containment device, such as a holding tank 154 for example. The holding tank 154 may include a body 220 having an inlet 222, and outlet 224, and a generally hollow interior 226 connected to the inlet 222 and the outlet 224. In the illustrated, non-limiting embodiment, the inlet 222 is formed at a first, upper end of the body 220, and the outlet 224 is formed at the bottom end of the body 220. However, embodiments where the inlet 222 and/or outlet 224 are formed at another location about the body 220, such as a sidewall 228 for example, are also contemplated herein.

In an embodiment, the environment within the hollow interior 226 of the holding tank 154 is a low-moisture environment, such as a gaseous environment with low humidity. A vent or opening 230 may be formed in a wall of the holding tank 154. At least some of the vaporized moisture within the free volume of the holding tank 154 may escape through the vent 230. In some embodiments, the hollow interior 166 of the holding tank 154 may be operably coupled to a vacuum device 232, such that the environment within the hollow interior 226 is a low-pressure environment. The vacuum device 232 is operable to actively pull vaporized moisture from the hollow interior 226 of the holding tank 154. The pressure within the hollow interior 166 resulting from application of the vacuum device 232 may be anywhere from atmospheric pressure up to a full vacuum (zero pressure).

Within the holding tank 154, the flowable jelly confection material 111 is configured to fall from the inlet 222 to the outlet 224, such as via gravity. In some embodiments, a nozzle 150 is arranged at or directly adjacent to the inlet 222 of the holding tank 154. The nozzle 150 may be angled relative to a longitudinal axis of the holding tank 154 to direct the heated jelly confection material 111 towards an interior surface of a sidewall 228 of the holding tank 154. In an embodiment, the nozzle 150 is configured to divide the flow of heated jelly confection material 111 at the inlet into a plurality of streams, thereby increasing the surface area of the heated jelly confection material 111 within the holding tank 154.

The temperature of the jelly confection material 111 may be substantially identical at the outlet 152 of the nozzle 150 and the outlet 134 of the scraped surface heat exchanger 109. However, embodiments where a small amount of heat is transferred from or to the jelly confection material 111 during travel between the outlet 134 and the nozzle 150, such as due to conduction or convection to the ambient atmosphere for example, are also within the scope of the disclosure. In embodiments where heat is lost between the scraped surface heat exchanger 109 and the nozzle 150, the temperature of the jelly confection material 111 at the nozzle outlet 152 may be at or above the boiling point of water (at standard temperature and pressure).

When the jelly confection material 11 is released from the outlet 152 of the nozzle 150 into the interior 226 of the holding tank 154, the liquid moisture located at or near the exterior surface of the jelly confection material 111 in contact with the surrounding atmosphere, vaporizes and is released from or off gasses from the jelly confection material 111. Further, because the jelly confection material 111 accelerates and the one or more streams of jelly confection material 111 thin as they fall via gravity, a new surface of the jelly confection material 111 is continuously exposed, resulting in a continuous release of the water vapor from the surface of the jelly confection material 111 until it reaches the bottom of the containment device 154. The continual exposure of a new surface of the jelly confection material 111 which causes a continuous release of moisture therefrom is a form of continued renewal similar to the mixing achieved within the extruder 12 in the embodiment of FIG. 1. In an embodiment, a jelly confection material 13 having a desired second percentage of solids, such as a high solids jelly for example, is collected at the bottom of the first containment device 154 and is output from the holding tank 154 via the outlet 224. Further, the water or moisture that is released from the jelly confection material 111 may be collected in a separate portion of the holding tank 154 or may be removed therefrom, such as via vent 230 as previously described.

Although only a single containment device 154 is illustrated in FIG. 4, it should be understood that in other embodiments, such as shown in FIG. 5, the moisture removal system 110 may include a plurality of containment devices arranged in series relative to the flow of jelly confection material. In such embodiments, the jelly confection material provided at the outlet of the last containment device in the series may be the jelly confection material 113 having a second percentage of solids. In the illustrated, non-limiting embodiment, the moisture removal system 110 includes a first containment device 154 and a second containment device 156. However, embodiments including additional containment devices arranged in series relative to the flow of jelly confection material are also within the scope of the disclosure. The plurality of containment devices, such as containment device 154 and 156 for example, may have a similar configurations. Further, the second containment device 156 may be arranged vertically beneath the containment device 154, and the jelly confection material 111 in the form of either a low solids jelly or a high solids jelly provided at the outlet 164 of the containment device 154 may further fall, via gravity, into the second containment device 156. However, embodiments where jelly confection material 111 is transferred from the containment device 154 to a downstream containment device 156 in another suitable manner are also contemplated herein.

The continuous removal of water vapor as the jelly confection material 111 falls causes the jelly confection material 111 to be “de-watered” to form the jelly confection material 113 having a desired second percentage of solids, such as a high solids jelly for example. In an exemplary embodiment, the jelly confection material 113 collected within the containment device 154 or the last containment device of a plurality of containment devices arranged in series has a second percentage of solids between 80%-95% solids, and more particularly 82%, 83%, 84%, 85%, 86%, 87%, 88%, 89%, 90%, 91%, 92%, 93%, 94% or 75% solids.

One or more parameters associated with the jelly confection material 111 at the outlet of nozzle 150 or the inlet 222 of the containment device 154 or associated with operation of the processing equipment, such as the containment device 154, the scraped surface heat exchanger 109, and/or the vacuum device 232 for example may be controlled to achieve the desired second percentage of solids of the jelly confection material 113 at the outlet of the moisture removal system 110. Examples of such parameters include, but are not limited to the flow rate at which the jelly confection material 111 is output from the nozzle 150 or provided to the inlet 222, the pressure acting on the jelly confection material 111 output from the outlet 152, the axial (vertical) distance over which water is to be removed from the jelly confection material 111, e.g. the distance between the inlet 222 and the outlet 224 of the one or more containment devices, and in some embodiments, the temperature of the jelly confection material 111, the temperature of the environment within the containment device 154, and the pressure or vacuum level within the containment device 154.

The jelly confection material 113 having the second percentage of solids, such as a high solids jelly for example, may have a solids content and composition substantially identical to that of the final jelly confection with only the addition of sensitive ingredients and/or crumble being optionally added. Similar to the embodiment described above with respect to FIGS. 1-3, sensitive ingredients, such as but not limited to those discussed above may be optionally added to the jelly confection material within the last containment device of the moisture removal system, or at a location downstream therefrom. Alternatively, or in addition, one or more sensitive ingredients, such as non-volatile temperature sensitive ingredients for example, may be added to the jelly confection material 111 at the nozzle 150 or inlet 222 of the containment device 154, within the conduit 138 extending between the scraped surface heat exchanger 109 and the nozzle 150 or inlet 222, within the annular passage 122 of the scraped surface heat exchanger 109, such as at or near the outlet 134 thereof once the jelly confection material 111 is heated to a desired temperature, or even within the jelly confection material 111 at a location upstream from the scraped surface heat exchanger 109.

As previously described, the jelly confection may include large particles. Such large particles may be incorporated into the jelly confection material 111 at any location upstream from where mixing occurs. In the non-limiting embodiment of FIG. 4, large particles may be added to the jelly confection material 111 within a portion of the moisture removal system 110, such as within the heating system 112. For example, large particles may be added to the jelly confection material 111 within the scraped surface heat exchanger 109, such as at any location upstream from the outlet thereof. Alternatively, or in addition, large particles may be incorporated into the jelly confection material 111 prior to entering the scraped surface heat exchanger 109.

One or more ingredients may be added as a coating or topping to the jelly confection material 113 output from a containment device 154 or a downstream extruder 170 to be described in more detail below. Ingredients added as a coating or topping to a surface of the jelly confection material 113 may be sensitive ingredients, or may be other ingredients, such as a crumble for example. Crumble ingredients, such as but not limited to those discussed above, may be added from a crumble supply, such as represented by 144, arranged at a location downstream of a containment device 154, or the last containment device within a series. Accordingly, depending on the composition of the jelly confection being formed, the jelly confection material 113, the jelly confection material 113 including sensitive temperature ingredients, or the jelly confection material 113 including both sensitive ingredients and a topping may be considered a final jelly confection material.

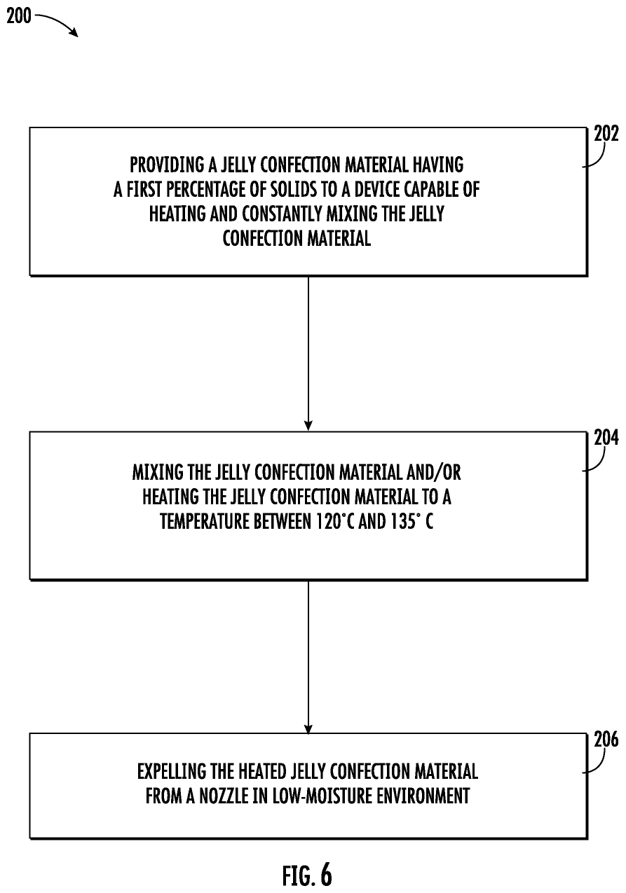

Referring now to FIG. 6, a block diagram depicting another method 200 for forming a jelly confection is shown. As shown in block 202, the method 200 includes providing a jelly confection material 111, such as low solids jelly containing a first percentage of solids for example, to an input of a device capable of heating and continuously mixing the jelly confection material. As shown in block 204, the method 200 additionally includes mixing the jelly confection material Lastly, as shown in block 206, the method 200 further includes expelling the heated jelly confection material 111 from a nozzle in a low-moisture, low pressure environment, thereby releasing at least a portion of the water vapor from the jelly confection material to form a jelly confection material 113 containing a second percentage of solids, such as a high solids jelly for example.

With continued reference to FIG. 4 and reference again to FIG. 1, the jelly confection material 13, 113 output from the moisture removal system 12, 110 may be in condition for further processing via one or more suitable downstream processes, to be described in more detail below. For ease of description, the processes that occur downstream from the moisture removal system 12, 110 are generally illustrated and described as being applied to a final jelly confection material 46, 146, and therefore occur after the addition of one or more optional sensitive ingredients to the jelly confection material 13, 113. However, it should be appreciated that embodiments where one or more sensitive ingredients and/or crumble are added after performing these downstream processes are also within the scope of the disclosure.

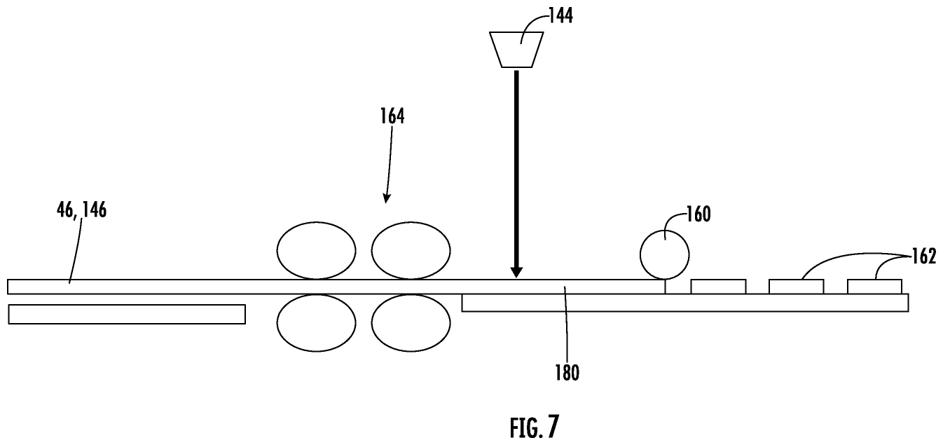

With reference to FIG. 7, in an embodiment, the jelly confection material 13, 113 output from the moisture removal system 12, 110 as a final jelly confection material 46, 146 may be immediately cut into pieces 162 for packaging via a cutting device 160, such as one or more cutting rollers or knives for example. However, in other embodiments, prior to cutting into pieces, the final jelly confection material 46, 146 may be conditioned (such as by exposing the final jelly confection material 46, 146 output from the moisture removal system 12, 110 to a temperature-controlled environment for a period of time). In embodiments where the final jelly confection material 46, 146 output from the moisture removal system 12, 110 is a high solids jelly, this conditioning may transform the high solids jelly to a stable high solids jelly.

Alternatively, or in addition to conditioning, the final jelly confection material 46, 146 may be formed and/or sized to form a confectionery structure having a desired shape and/or thickness, such as a sheet or rope for example, prior to being cut into pieces 162 of jelly confection. In an embodiment, the forming and/or sizing of the final jelly confection material 46, 146 is performed via a forming station 164 having a series of forming rollers (see FIG. 7) operable to gradually reduce the thickness of the final jelly confection material 46, 146 to its final thickness. In another embodiment, shown in FIG. 4, the forming and/or sizing of the final jelly confection material 46, 146 is performed via a forming station 164 having a single set of rollers (166, 168) configured to reduce the final jelly confection material 46, 146 all the way to its final thickness.

In an embodiment, the final jelly confection material 46, 146 has a uniform shape, including a uniform thickness, such as a sheet or rope for example, when provided to an inlet of the forming station 164. For example, with reference to FIG. 1, final jelly confection material 46 may be sized and shaped into a sheet or rope having a uniform thickness as the final jelly confection material 46 is output from the extrusion point 26 or die of the extruder 12. Similarly, with reference to FIGS. 4 and 6, the final jelly confection material 146 from the most downstream containment device 154 may first be extruded into a sheet or rope, such as via extruder 170, before being provided to the forming station 164. In an embodiment, one or more temperature sensitive ingredients may be added to the jelly confection material 113 to form the final jelly confection material 146 within the extruder 170.

In other embodiments, the final jelly confection material 46, 146 at a location upstream from the forming station 164 may be “unshaped” having an irregular or non-uniform shape and/or thickness. In such embodiments, as shown in FIG. 4, the final jelly confection material 46, 146 may be accumulated, such as within a hopper 172 for example, into an unshaped mass directly upstream of the single set of rollers or the first set of rollers in the series of rollers if such rollers are employed.

Regardless of the configuration of the forming station 164 and whether the final jelly confection material 46, 146 was provided thereto with a uniform or non-uniform thickness, the final jelly confection material 46, 146 output from the forming station 164 may be a sheet or rope 180 having a final thickness. In such embodiments, the sheet or rope 180 may be provided to the one or more cutting devices 160 to cut the sheet or rope 180 into a plurality of pieces of a jelly confection.

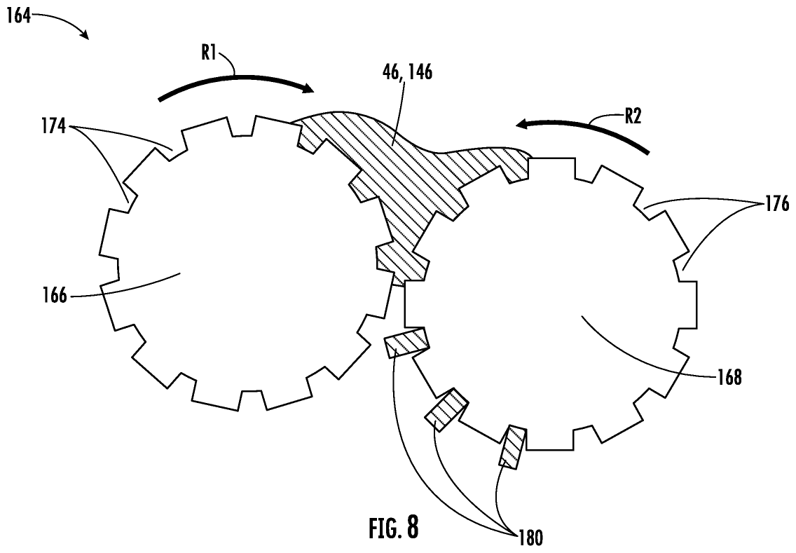

In other embodiments, with reference to FIG. 8, the forming station 164 may be used to both size and shape the final jelly confection material 46, 146 into a plurality of individual pieces, thereby eliminating the need for the downstream cutting device 160. In such embodiments, at least one of the rollers, and in some embodiments, a pair of corresponding rollers 166, 168, of the forming station 164 has a plurality of cavities formed about a periphery thereof. For example, the first roller 166 may have a plurality of first cavities 174 formed therein, and the second roller 168 may have a plurality of second cavities 176 formed therein. The outer surfaces of the first and second roller 166, 168 may be offset from one another to define a nip therebetween, or alternatively, may have substantially no clearance.

In embodiments where each of a pair of rollers 166, 168 has cavities 174, 176 formed therein, the cavities 174 of one roller 166 may be generally complementary to and configured to align with a corresponding cavity 176 of the other roller 168 to form a three-dimensional shape extending from the nip towards the axis of both the first roller 166 and the second roller 168. In such embodiments, each cavity, or pair of cavities 174, 176 may be associated with an individual piece 182 of a jelly confection. Accordingly, as the final jelly confection material 46, 146 is compressed by the at least one roller 166, 168, the final jelly confection material 46, 146 fills the cavities or pairs of aligned cavities 174, 176 formed in the rollers 166, 168. When the jelly confection material is removed from the cavities 174, 176, the individual pieces of jelly confection material have a three-dimensional shape corresponding to the three-dimensional shape of the pair of aligned cavities 174, 176. In an embodiment, the three-dimensional shape of the pieces is defined by a lack of flat surface which extends the length of piece or alternatively, as having contours on all sides of the piece.

It should be appreciated that the existing stoving process which includes deposition of a jelly slurry into an open mold results in a shaped jelly confection having at least one flat or planar surface, defined by the opening of the mold. Accordingly, the traditional stoving process is not suitable to form a jelly confection having a three-dimensional shape similar to that using a pair of rollers 166, 168 as described above or chain dies.

As noted above, in traditional stoving methods, the heat directed to a surface of the jelly mixture to assist with devolatization often creates a skin around at least one surface of the resultant jelly confection. The formation of this skin, which is texturally different than the remainder of the jelly precludes any portion of the jelly confection from being recycled. However, because the diffusivity of the jelly confection mixture formed via a system and/or method as described herein is substantially uniform, meaning that no skin is formed while the percentage of solids of the material is increased, the jelly may be recycled. Accordingly, the jelly confection material 11, 111, 13, 113, or the final jelly confection material 46, 146 may be recycled.

For example, if the percentage of solids of the jelly confection material 13, 113 output from the moisture removal system 12, 110 is less than a desired amount, the jelly confection material 13, 113 may be returned to the moisture removal system 12, 110, such as at a location upstream from where the moisture is removed therefrom. Alternatively, or in addition, if scraps of a final jelly confection material 46, 146 are generated, such as when forming or cutting the final jelly confection material individual pieces, the excess material may be returned or provided to a manufacturing components used during the manufacturing process. Alternatively, the excess material may be provided to a component that was not used during the manufacturing process. For example, the excess or scrap material may be provided to an extruder separate from the moisture removal system 12, 110 operable to extrude the recycled material as a sheet or rope for further processing, such as cutting or forming.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present.

1. A method for forming a jelly confection, the method comprising:
providing a jelly confection material to a moisture removal system;
continuously renewing an exterior surface of said jelly confection material via said moisture removal system;
removing moisture from said jelly confection material via said moisture removal system;
outputting said jelly confection from said moisture removal system, and
forming said jelly confection material into a plurality of pieces of jelly confection.

2. The method of claim 1, further comprising outputting said jelly confection material from an outlet of said moisture removal system, wherein a percentage of solids of said jelly confection material at said outlet is greater than said percentage of solids when said jelly confection material is provided to said moisture removal system.

3. The method of claim 2, wherein at least one of said jelly confection material at said outlet of said moisture removal system is a high solids jelly and said jelly confection material provided to said moisture removal system is a low solids jelly.

4. (canceled)

5. The method of claim 1, further comprising mixing said jelly confection material within said moisture removal system.

6. The method of claim 5, wherein said continuously renewing said exterior surface of said jelly confection material occurs via said mixing.

7. The method of claim 1, wherein said moisture removal system is an extruder.

8. (canceled)

9. (canceled)

10. (canceled)

11. The method of claim 2, wherein said moisture removal system includes a mixer, and said method further comprises outputting said jelly confection material from an outlet of said mixer, wherein said percentage of solids of said jelly confection material at said outlet of said mixer is equal to said percentage of solids of said jelly confection material provided to said mixer.

12. (canceled)

13. The method of claim 11, wherein said moisture removal system further comprises a nozzle fluidly coupled to said mixer, said method further comprising:
providing said jelly confection material from said outlet of said mixer to said nozzle; and
releasing said jelly confection material from said nozzle into a low-moisture, low pressure environment, said removing moisture from said jelly confection material occurring upon said releasing of said jelly confection material from said nozzle.

14. (canceled)

15. (canceled)

16. (canceled)

17. The method of claim 1, further comprising at least one heating said jelly confection material within said moisture removal system to a temperature of 95° C.-150° C. and adding at least one sensitive ingredient to said jelly confection material after said removing moisture from said jelly confection material.

18. (canceled)

19. The method of claim 1, wherein during said continuously renewing said exterior surface of said jelly confection material, said jelly confection material has a consistent moisture diffusivity in a plane perpendicular to a flow direction of said jelly confection material.

20. A method of forming pieces of a jelly confection, the method comprising:
mixing a jelly confection material in a moisture removal system;
outputting said jelly confection material from said moisture removal system, said jelly confection material output from said moisture removal system being a high solids jelly; and
forming said jelly confection material into a plurality of pieces of jelly confection having a three-dimensional shape using a forming station.

21. The method of claim 20, wherein said forming station includes at least one roller, said at least one roller having a plurality of cavities formed about a periphery of said at least one roller for receiving said jelly confection material, said forming said jelly confection material into said plurality of pieces of jelly confection having said three-dimensional shape includes compressing said jelly confection material into said plurality of cavities.

22. (canceled)

23. (canceled)

24. (canceled)

25. (canceled)

26. The method of claim 25, further comprising extruding said jelly confection material at a location upstream from said forming station.

27. (canceled)

28. (canceled)

29. A method of forming a jelly confection comprising:
adding at least one particle to a jelly confection material, said at least one particle having a dimension greater than 4 mm;
mixing said jelly confection material in a moisture removal system;
removing moisture from said jelly confection material within said moisture removal system; and
outputting said jelly confection material from said moisture removal system.

30. The method of claim 29, wherein mixing said jelly confection material encapsulates said at least one particle within said jelly confection material, said jelly confection material being a high solids jelly.

31. The method of claim 29, wherein said at least one particle includes a plurality of particles and said mixing said jelly confection material uniformly distributes said plurality of particles within said jelly confection material.

32. The method of claim 29, wherein said adding said at least one particle having said dimension greater than 4 mm to said jelly confection material occurs at least one of upstream from at least a portion of said mixing said jelly confection material and after said removing moisture from said jelly confection material.

33. (canceled)

34. (canceled)

35. (canceled)

36. A method for forming a jelly confection, the method comprising:
providing a jelly confection material to a moisture removal system;
removing moisture from said jelly confection material via said moisture removal system;
forming said jelly confection material into a plurality of pieces; and
adding at least one sensitive ingredient to said jelly confection material prior to forming said jelly confection material into said plurality of pieces.

37. The method of claim 36, wherein said adding said at least one sensitive ingredient occurs within said moisture removal system or after said removing moisture from said jelly confection material.

38. (canceled)

39. (canceled)

40. The method of claim 36, wherein said jelly confection material is provided having a first percentage of solids and after said removing moisture from said jelly confection material, said jelly confection material has a second percentage of solids, said second percentage of solids being greater than said first percentage of solid.

41. (canceled)

42. (canceled)

43. The method of claim 40, wherein said at least one sensitive ingredient is added to said jelly confection material having said second percentage of solids.

44. -69 (canceled)
